(19) United States
(12) Patent Application Publication
(10) Pub. No.: US 2011/0034579 A1
(43) Pub. Date: Feb. 10, 2011

(54) POLYURETHANE FILTERS FOR AIR PURIFICATION

(76) Inventors: Moises Luzia Goncalves Pinto, Lisboa (PT); Joao Manuel Pires DA Silva, Amadora (PT); Joao Carlos Moura Bordado, Lisboa (PT); Antonio Nunes Barata, Barreiro (PT); Jose Boavida Valente, Baxia da Banheira (PT)

Correspondence Address: MAIER & MAIER, PLLC, 1000 DUKE STREET, ALEXANDRIA, VA, 22314, US

(21) Appl. No.: 12/936,333

(22) PCT Filed: Apr. 2, 2008
(86) PCT No.: PCT/PT2008/000013

§ 371 Date: Oct. 4, 2010

(51) Int. Cl. C08J 9/00

(52) U.S. Cl. 521/172; 521/170

(57) ABSTRACT

A process for producing polyurethane foam filter material with adsorption capabilities, containing a solid adsorbent, that comprises a one shot process of reacting a polyurethane foam-forming formulation, comprising isocyanates and polyesters or polyethers, catalysts, silicone oils and water, characterized in that particles of the adsorbent material are included directly in the foam-forming formulation, without any surface pretreatment, after cleansing by heating. The resulting filter material can be sliced in plates of various thicknesses according to the intended particular use, and this use can be in air filtering systems, for purification of air or water, ion-exchange, deodorization, drying, prevention of public hazards, or the separation and purification.

### BACKGROUND AND FIELD OF THE INVENTION

The present invention relates to the production of filter materials with adsorption capabilities. This type of filters presents additional characteristics besides mechanical filtering of solid particles from fluid streams due to the presence of an adsorbent material that can also remove undesired compounds. Standard filters do not have this capability because most molecules present in the filtering stream that constitute organic vapors or odors are too small to be retained in the structure of the filters, even in high efficiency filters. The introduction of adsorbent materials in filtering systems can remove most of these compounds by a physical process called adsorption.

Adsorbent materials are known since antiquity, although in the last century they have been wildly applied in industrial processes, from purification to catalysis. They are characterized by a porous structure, normally with pores form 0.5 to 100 nm, which is responsible for the retention of molecules in their interior. They can occur in the nature as mineral materials, but for most applications they are prepared by different processes in order to have adequate characteristics for the application envisaged.

One important field of application of these materials is in the filtration of air in ventilation and air conditioning systems, to improve the air quality inside buildings. It is now known that the presence of volatile organic compounds in the interior of buildings contributes to the incidence of some diseases. The use of adsorbent materials in the removal of volatile organic compound from gaseous streams is already known for several decades and the application of these materials in the purification of the indoor air can improve the quality of this air.

### STATE OF THE ART

Adsorbents have generally being used with high efficacy in the purification of air. However, most of the adsorbents are obtained in powder or in pellet form, which can hinder and limit their application. This aspect is of particular importance when one intends to use adsorbent materials in the purification of gaseous streams, raising the importance of the development of filters that contain or immobilize the adsorbent. One approach to this problem is the production of adsorbent materials to be used directly as filters, as is the case of the ones made of activated carbon fibbers and some polymer carbonized materials. These materials are usually obtained by producing an organic or composite matrix that is later carbonized, presenting, in this way, several technical and economical disadvantages. Another alternative is to support the adsorbent materials in adequate porous matrices. This can be used to support adsorbents with the desired characteristics for the purification of a fluid stream, allowing for an easier preparation of a filter with characteristics closer to the desired ones.

To this general objective of supporting the adsorbents, various methods are already available. The adsorbents can be supported in fiber or textile porous matrices by using an adhesive or binder solution. Different methods use this approach to produce filters with adsorption capacity, which are disclosed in several patents like, for example, U.S. Pat. No. 4,510,193, U.S. Pat. No. 4,517,308, U.S. Pat. No. 4,981,501, U.S. Pat. No. 5,662,728, U.S. Pat. No. 5,972,427, U.S. Pat. No. 6,177,069, U.S. Pat. No. 6,227,383, U.S. Pat. No. 6,550,622, U.S. Pat. No. 6,746,760, U.S. Pat. No. 6,762,139, U.S. Pat. No. 6,890,373. In these patents a coating of adsorbents, usually in powder form, is fixated to a pre-existing support using an adhesive or binder. Relatively similar to these processes is the application of a coating of adsorbent materials to pre-existing polyurethane matrices, using a binder or a thermoplastic (U.S. Pat. No. 5,820,927, U.S. Pat. No. 5,871,569). Other ways of making an adsorbent filter are to bind the adsorbent particles together with a binder or thermoplastic, to form a porous structure that is constituted by the adsorbent particles themselves (U.S. Pat. No. 5,332,426, U.S. Pat. No. 5,665,148, U.S. Pat. No. 5,767,060).

The feasibility of the inclusion of adsorbent materials in formulations of polyurethane foams, to obtain composite materials with adsorption capabilities was previously disclosed (for example in U.S. Pat. No. 3,865,758). However in U.S. Pat. No. 3,865,758 the adsorbent (an activated carbon) always have to be surface treated. These surface treatments always imply not only additional steps in the production process to subsequently remove the applied polymeric coating from the surface of the adsorbent particles, by means of solvents, but also, since the use of solvents saturates the supported adsorbents which loose in this way its adsorption capacity, it is necessary to restore this capacity by heating the final material under vacuum for several hours. Thus, this method of supporting adsorbents is not very efficient particularly at industrial scale since it comprises additional production steps, and involves noxious solvents, heating and vacuum, just to remove the protective coating of the adsorbent particles.

Accordingly, a rapid and simple process, including a minimum of steps and avoiding the use of hazard and expensive materials, which provides a composite material for use in filters with adsorption characteristics, is needed and has great economic and industrial advantages.

Is this the problem now solved by the present invention which provides a process for producing a composite material for use in filters including adsorbents in its formulation, characterized in that the referred filter material with adsorption properties is obtained in a one shot reaction and can be used directly without any further treatment.

Thus, the present invention obviates the need of the surface treatment of the adsorbent with solvents of the prior art processes, obviating in this way not only the additional steps of the treatment itself but also the subsequent steps for restoration of the adsorbent properties lost in that treatment. Also, using this one shot process the adsorbent materials became attached to the reticulated and tortuous structure of the filter media without the use of binders or adhesives.

### DISCLOSURE OF THE INVENTION

The present invention provides a process for producing a polyurethane foam filter material with adsorption properties containing solid adsorbents characterized in that it comprises a one shot process of reacting a polyurethane foam-forming formulation, the formulation including at least one isocyanate and at least one of polyesters or polyethers, at least one catalyst, at least one silicone oil, water and including directly at least one solid adsorbent with particle dimensions within the conventional particle size range of granular adsorbents, preferably between 1 and 4 mm, without any surface pretreatment. The invention also refers to the filter base materials obtained by this one shot process and the uses of these materials in the manufacture of filters with adsorption capabilities for use in filtering systems.

The process according to the present invention has industrial and economic advantages over the prior art processes, by reducing the number of unit operations that are needed to produce the filter media with adsorption capabilities.

The filter materials obtained by this process are used directly in the manufacture of filtering systems with particular interest for applications in air filtering systems combining the ability of retaining solid particles with the possibility of retaining noxious volatile organic compounds (VOCs), which are major contributors to the pollution of indoor air. The possible applications of these materials depend highly on their final adsorption capacities for VOCs, particularly at low relative pressures. Applications to other similar areas include, without limitation, the purification of air or water, ion-exchange, deodorization, drying, prevention of public hazards, or the separation and purification, for example.

Contrary to prior art processes, according to the present invention the adsorbents are included in the formulation of the foams, during their synthesis, to obtain in this way composite foams. The present inventors have surprisingly found that the careful control of the kinetics and of the reokinetics allow for a rather fast raise in viscosity and this sharp increase of viscosity will drag-up the carbon particles independently of their size or shape within the conventional particle size range of the granular adsorbents, thus obtaining a final foam material having a homogeneous cell structure, a high open cell content and high air permeability, a homogeneous distribution of the adsorbent particles and a high adsorption capacity, that are suitable for the application of the material in filtering systems. This unique bonded multicomponent medium allows use of both polymer and adsorbents in a common filter vessel thus simplifying using, operation, and maintenance of filtration equipment.

In the process according to the invention the binder of the adsorbent particles is the foam material itself so that the process does not require any other binder material or adhesive. The absence of binders or any other adhesive material around the adsorbent particle increases the access of the air and thus increasing the removal of volatile organic compounds.

### BEST MODE FOR CARRYING OUT THE INVENTION

According to the present invention, a process is provided for producing a polyurethane foam base material for filters with adsorption capabilities characterized in that it comprises a one shot reaction of a polyurethane foam-forming formulation which includes at least one isocyanate, at least one of polyesters or polyethers, at least one catalyst, at least one silicone oil, water, and at least one solid adsorbent.

The main concept of the process according to the present invention is to minimize the contact time between the adsorbent material and the other components to avoid impregnation of the adsorbent particles and consequent loss of adsorption capacity. This is done by carefully control the kinetics and reokinetics of the mixture to allow for a rapid rise of the foam and a good distribution of the adsorbent particles. This should be done with a control of the amount and type of catalysts used, combined with the adequate timing for the mixture of the components, as herein described. If this is not achieved the final foam material will not have the minimum characteristics necessary for the application in filters.

In this way, some important production conditions should be attained, as can also be noted in the given examples. The reaction mixture should have a relatively high amount of catalyst, usually between 0.25 and 1% by weight of the polyol, for the polymerization reaction, in order to promote a sufficiently high polymerization velocity and consequent rise of the viscosity of the mixture. This has a benefit effect in the distribution of the adsorbent by increasing the terminal velocity of the adsorbent particles in the rising foam, and also by avoiding the impregnation of the adsorbent particles with the liquid components of the polyurethane formulation. In this perspective, the use of polyols and isocyanates with a relatively high initial viscosity also helps in the distribution of the adsorbent particles in the final foamed material. Also important to note is the cleaning of the adsorbents to be used in the manufacturing of the composite foam, otherwise the temperature rise during the foaming and polymerization will promote the desorption of the components from the adsorbent. The released gases can produce large cavities around the adsorbent particles, giving non homogeneous foams, which impairs the use of the final material as a filter. This is particularly true when adsorbents with very high specific area are to be used. The adsorbent material can be cleaned by applying vacuum or by heating it at high temperatures of about 100 to 300° C., or by combination of the two processes. This operation should be performed immediately before the application of the required amount of adsorbent material in the formulation of the composite foam.

The standard production methods can be applied in the production of the material, such as casting process in molds as well as in a continuous process (slabstock). Components forming polyurethane foams and suitable reaction techniques are well known and are reported in many publications, for example, in the some of the prior patents mentioned above.

The silicone oils normally used as foam stabilizers in standard polyurethane foams can be applied in the formulation of the composite foams according to the invention. They usually comprise copolymers of polyethers and polysiloxanes, with variable chain length and variable polyether/polysiloxane ratio. The use of these types of compounds as foam stabilizers is very common in polyurethane technology and the effects of different types of silicones in the structure of the final polyurethane foams is described in the specific literature. The silicone oils should be chosen to improve the regularity of the cellular structure, but also should give foams with high open cell content and high air permeability, to reduce the pressure drop when applying it as a filtering material. The choice of silicone oils with properties that improve the flame retardant characteristics of the final material can also be made.

The adsorbents that are best suited to be used in the process according to the invention include the adsorbent materials with surface areas above 500 m²/g, preferably above 1000 m²/g. This will allow obtaining a final material with a sufficiently high surface area to have an effect in the removing of contaminants from the filtered stream. The possible adsorbents include, without limitation, activated carbons, zeolites, clays, silicas, aluminas, silica-alumina, regular mesoporous silicas, or mixtures thereof. The use of modified or specially designed adsorbent materials to selectively and more efficiently adsorb a specific type of contaminants is also possible in an analogous way of the more standard adsorbents referenced. The particle size of the adsorbents should be within the conventional particle size range of granular adsorbents, and should be, preferably, between 1 and 4 mm, in granular or pellet forms. As shown below in Example 2, the adsorption capacity of the base material obtained with the process of the invention depends on the amount of adsorbents included. Thus, the amount of adsorbents used according to the invention can be varied depending on the desired properties for the final filter and preferably will be up to 40% by weight of the final material.

To be successfully used in the production process according to the present invention, the adsorbents should be cleaned by heating them at high temperatures. Preferably the heating of the adsorbent is made by heating the particles in an open container at temperatures approximately from 120° C. to 150° C., during at least two hours. The material is then allowed to cool down to at least around 80° C., and is then mixed with the other components of the formulation.

The main components of the foam-forming formulation according to the invention, namely the polyols and the isocyanates, are those adequate for producing flexible foams, to obtain a flexible final material. This flexibility avoids breakage and cracks when cutting in thin sheets and makes easy the use of the final filtering material. Although the basic materials employed in the process are commonly available, some special procedures that will be hereafter described and the relative amounts of the components employed, as well as the preferred types disclosed in the following text, should be strictly respected in order to obtain a final material that can be used to produce filters with adsorption capacity.

Examples of these components forming polyurethane foams that can be used in the process according to the invention include polyesters made from acid selected from the group consisting of, without limitation, succinic acid, glutanic acid, adipic acid, suberic acid, azelaic acid, sebacic acid, phthalic acid, iso-phthalic acid, dodecanedicarboxylic acid, and a glycol selected from the group consisting of, without limitation, ethylene glycol, 1,2-propylene glycol, 1,3-propylene glycol, 1,3-butylene glycol, tetramethylene glycol, diethylene glycol, triethylene glycol, pentamethylene glycol, hexamethylene glycol, xylylene glycol; polyethers such as, without limitation, poly(oxypropyl ene)glycols, poly(oxypropylene)-poly(oxyethylene)copolymer glycols, poly(oxybutylene)glycols, poly(oxyethylene)glycols, poly(oxytetramethylene)glycols, poly(oxypropylene)glycerols, poly(oxypropylene)trimethylolpropanes, poly(oxypropylene)-1,2,6-hexanetriols, poly(ethyleneoxide propyleneoxide ethylenediamine)polyethers, poly(oxyalkylene)sorbitols, poly(oxyalkylene) pentaerythritols, poly(oxyalkylene)sucrose, poly(oxyalkylene)glucose, and mixtures thereof; and isocyanates such as, without limitation, tolylene diisocyanate, 3,3-bitolylene-4,4′-diisocyanate, diphenyl methane-4,4′-diisocyanate, 3,3′-dimethyl diphenyl methane-4,4′-diisocyanate, 2,4-tolylene diisocyanate dimer, 1,5-naphtylene diisocyanate, m-phenylene diisocyanate, triphenylmethane-4,4′,4″-triisocyanate, hexamethylene diisocyanate, and mixtures thereof. The viscosity of the polyols and isocyanates is preferably about 600 mPa s, or higher.

According to the process of the invention, the reaction should be catalyzed by adding catalysts to the polyol. The most used types of catalysts for this purpose are based in organomethalic compounds, namely organotin compounds, but any other catalysts which selectively promote the formation of urethane bonds can be used in principle. Preferably, tin based catalysts are used in the process according to the invention, such as, for example, tin octoate, or dibutyltin diacetate, or dibutyltin dilaurate, or any other stannous catalyst. The use of tertiary amines to catalyze the expansion reaction can also be considered by the addition of, for example, trimethylamine, triethyamine, tripropylamine, tributylamine, tripentylamine, 1,4-diazabicyclo[2.2.2]octane, or any other based on organic molecules that contain a tertiary amine as a functional group. The use of high boiling point catalysts should be preferred in order to avoid vaporization, during the foaming process, and adsorption in the adsorbent materials present in the reaction mixture, with consequent loss of adsorption capacity. The polymerization reaction should be catalyzed by the addition of a sufficient amount of catalyst to induce a rapid rise in the viscosity of the mixture and assist the distribution of the adsorbent particles in the foam.

The reaction of the components can be performed by various standard means, and the most frequently used includes the mixing of the polyether(s) and/or polyester(s) to small amounts of water, silicone surfactant(s) and catalyst(s), and adding the isocyanate(s) and the adsorbent(s) to the resulting mixture, and apply a strong stirring to the mixture.

The reaction can be carried out in the presence of known additives for polyurethane foams. Examples of additives include dyes or fillers such as carbon black to change the final color of the material, or halogenated compounds as flame retardants. Before being sliced in the desired shape, the so obtained material is allowed to cure from 3 to 8 days, depending on the cure conditions.

The present invention also provides a filtering base material of polyurethane foam obtained by the reaction of the foam formulation according to the invention, which is a composite material of open cell polyurethane foam with adsorbent particles uniformly distributed and supported in their interior. The polyurethane foam material produced by the process of the invention has an adsorption capacity based on the adsorbent material in addition to a mechanical filtering effect based on the polyurethane foam. The material properties can be adjusted by adjusting the reaction formulation, to present specific gravity between 15 kg/m³ up to 85 kg/m³, preferentially between 25 and 45 kg/m³, with different cell sizes and with open cell volumes higher than 95%.

The filtering base material of polyurethane foam obtained according to the present invention, after the reaction and cure, is ready to be sliced and used as a material for filters. The material can be sliced in plates of various thicknesses according to the particular use in filtering systems. There is no need for an additional processing to restore the adsorbent capacity by means of a solvent, which would also imply another step for cleaning the adsorbent with the heating under reduced pressure, that are needed in prior art processes.

Optionally, the base material obtained with the process of the invention can be impregnated with a solution of auto-adhesive glue or a solution of polymer with permanent tackiness to improve the retention of solid particles, with corresponding improvement in the filtering capacity.

The cutting of the foam can be made by a mechanical saw or blade, or a hand cutting tool. The industrial standard cutting techniques for polyurethane foams can be applied in industrial scale production. The more common process is to cut the material, usually in sheets of different thicknesses depending on the particular adsorption capacity and application envisaged, by means of cutting machines used in the polyurethane industry. The application of automatic horizontal cutting machines, with a moving blade and moving platform, permit the fast cutting of the produced foam material with adsorbents in sheets of thickness from 3 to 100 mm, preferably from 5 to 7 mm. These sheets are ready to be applied in the production of filters with adsorption capacity by additional cutting and mounting in frames.

The present invention will now be illustrated in more detail in the following non limiting Examples. Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art of this detailed description.

### EXAMPLES

### Example 1

5.00 kg of activated carbon in pellets of 1 mm in diameter and variable length was heated to temperatures of about 120 to 150° C., during 2 hours. The activated carbon had a surface area above 1000 m²/g and was essentially microporous (pores between 0.3 and 1.5 nm).

6 kg of a polyether triol having a molecular weight of about 3000 (54-56 mgKOH/g) was mixed with 38 g of polyether polydimethylsiloxane copolymer (silicone oil) with a viscosity of about 650 mPa s at 25° C., 28 g of polyether polydimethylsiloxane copolymer (silicone oil) with a viscosity of about 1100 mPa s at 25° C., 264 g of distilled water, 15 g of stannous catalyst, and 5.09 g of 1,4-diazabicyclo[2.2.2]octane by stirring with a blade propeller at more than 1000 r.p.m. for about 1 minute.

To this mixture 5.16 kg of polymeric diphenyl methane-4,4′-diisocyanate (315 mgNCO/g) with a viscosity of 550 mPa s at 25° C. was added and a strong stirring with a blade propeller at more that 1000 r.p.m. was applied for 15 s. Immediately after, without stopping the stirring, the previously heated activated carbon was added and stirring was maintained for about 10 s. This operation was done when the activated carbon was at a temperature below 80° C. The mixture was then poured into a mould of about 1 m³, allowed to foam and solidify.

The resulting foam material was removed from the mould after 24 h and leaved to cure for 8 days, before being sliced in sheets of 5 mm in thickness with a blade cutting machine. These sheets presented an adsorption capacity of toluene vapor of 67 mg per gram of filter, at a partial pressure of 0.01, and 176 mg per gram of filter, at a partial pressure of 0.4, at 25° C. The foam presented an open cell volume of 98%.

### Example 2

The above described procedure was repeated but using 2.04 kg of the same activated carbon. The final foamed material was cut in an analogous way as in Example 1. In this case the sheets presented an adsorption capacity for toluene vapor of 33 mg per gram of filter, at a partial pressure of 0.01, and 115 mg per gram of filter, at a partial pressure of 0.4, at 25° C.

This example shows by comparison with the adsorption results for Example 1 that the adsorption capacity of the final material is dependent on the amount of activated carbon used when producing the foam. This is more noticed at low relative pressure, i.e. at low concentration of pollutants, which is the concentration range where the pollutants are normally found in gaseous and liquid streams. The amount of activated carbon included in the formulation can thus be varied depending on the desired adsorption capacity and specific application envisaged.

### Example 3

For comparison, the procedure described in Example 1 was repeated with a powder activated carbon with particles below 0.074 mm, and a surface area above 1000 m²/g. The final foamed material was cut in an analogous way as in Example 1. In this case the final material presented no appreciable adsorption capacity for toluene vapor, especially at low relative pressures (i.e. low concentrations).

The objective of this example is to show that when a powder adsorbent is used the final material does not have an adsorption capacity to be used as an adsorption filter. As already described, the preferred adsorbent materials should have a granular, pellet or similar from, with the preferred particles sizes between 1 and 4 mm.

### Example 4

For comparison, the procedure described in Example 1 was repeated but without the initial step of heating the activated carbon. In this case the activated carbon was mixed at ambient temperature directly with the other components as described in Example 1.

The final foamed material was cut in an analogous way as in Example 1. This material presented a similar adsorption capacity as the material obtained in Example 1. However the cellular structure of the foam has not homogeneous, and the sheets presented holes that passed from one side to the other, like small channels, with 2 to 5 mm in diameter. It is obvious that this material can not be used as a filter due to the lack of homogeneity of the structure and to the possibility of relatively large particles not being retained in the filter. This material could only be applied in situations where the particle retention properties of the obtained material are not important.

Many modifications of Examples 1 and 2 could also be presented, in order to vary the cell dimensions by changing the amount of water added and adjust the other components accordingly, or to change the color or obtain a auto-extinguishable foam by including some additives, or to obtain a more flexible or rigid foam by changing the polyol or adding different polyols, or to specifically and selectively adsorb a compound by changing the type of adsorbent used in the production of the foam. Yet, these various changes and modifications are considered as obvious modification, within the spirit and scope of the invention, to those experienced in the formulation of polyurethane foams and adsorbent materials.

1. A process for producing a polyurethane foam base material for filters with adsorption properties, characterized in that it comprises a one shot reaction of a polyurethane foam-forming formulation comprising a mixture of at least one polyisocyanate, at least one polyol, at least one silicone oil, at least one catalyst and water, which includes the addition of solid adsorbents during the foaming process without any surface pre-treatment in addition to a previous cleansing of the solid adsorbents by heating before being mixed in the foam forming formulation and in which the polymerization reaction is highly catalysed to produce a fast raise of the foam with the adsorbent.

2. A process according to claim 1, wherein mat the said solid adsorbents are included in the foam forming formulation by adding the solid adsorbents immediately after the mixing of the last component of the liquid formulation.

3. A process according to claim 1, wherein the cleansing of the solid adsorbents is done by heating at temperatures from 100° C. to 300° C., preferably between 120° C. to 150° C., during at least two hours, with or without the application of vacuum, the cleaned solid adsorbents being mixed with the foam forming formulation at a temperature between 100° C. and 40°, preferably at about 80° C.

4. A process according to claim 1, wherein the catalyst or catalysts are any catalyst for the formation of urethane bonds, preferably an organometallic catalyst with high boiling point, more preferably an organotin catalyst, yet more preferably tin octoate, dibutyltin diacetate, dibutyltin dilaurate, and is/are used in a relatively high amount sufficient to induce a fast raise of the foam, preferably between about 0.25% and 1% by weight of the polyol.

5. A process according to claim 1, wherein the said solid adsorbents are activated carbons, or zeolites, or clays, or silicas, or aluminas, or silica-alumina, or regular mesoporous silicas, or mixtures thereof.

6. A process according to claim 1, wherein the solid adsorbents have particle dimensions within the conventional particle size range of granular adsorbents, preferably between 1 and 4 mm.

7. A process according to claim 1, wherein the solid adsorbents are included in an amount that can be varied up to 40% weight of the final material.

8. A process according to claim 1, wherein the polyisocyanate is preferably a high viscosity polyisocyanate, more preferably tolylene düsocyanate, 3,3-bitolylene-4,4′-diisocyanate, diphenyl methane-4,4′-diisocyanate, 3,3′-dimethyl diphenyl methane-4,4′-diisocyanate, 2,4-tolylene diisocyanate dimer, 1,5-naphtylene diisocyanate, m-phenylene diisocyanate, triphenylmethane-4,4′,4″-triisocyanate, hexamethylene diisocyanate, and mixtures thereof.

9. A process according to claim 1, wherein the polyol is preferably a polyester made from an acid selected from the group consisting of succinic acid, glutanic acid, adipic acid, suberic acid, azelaic acid, sebacic acid, phthalic acid, iso-phthalic acid, dodecanedicarboxylic acid, and a glycol selected from the group consisting of ethylene glycol, 1,2-propylene glycol, 1,3-propylene glycol, 1,3-butylene glycol, tetramethylene glycol, diethylene glycol, Methylene glycol, pentamethylene glycol, hexamethylene glycol, xylylene glycol; or a polyether such as poly(oxypropylene)glycols, poly(oxypropylene)-poly(oxyethylene)copolymer glycols, poly(oxybutylene)glycols, poly(oxyethylene)glycols, poly(oxytetramethylene)glycols, poly(oxypropylene)glycerols, poly(oxypropylene)trimethylolpropanes, poly(oxypropylene)-1,2,6-hexanetriols, poly(ethyleneoxide propyleneoxide ethylenediamine)polyethers, poly(oxyalkylene)sorbitols, poly(oxyalkylene) pentaerythritols, poly(oxyalkylene)sucrose, poly(oxyalkylene)glucose; or mixtures thereof.

10. A process according to claim 1, wherein the silicone oil is a copolymer of polyethers and polysiloxanes, with variable chain length and variable polyether/polysiloxane ratios.

11. A process according to claim 1, wherein it is based on a casting process in mould or in a continuous process (slabstock).

12. A process according to claim 1, further comprising obtaining a filtering base material of polyurethane foam with adsorption capabilities that is a composite material of open cell polyurethane foam with adsorbent particles uniformly distributed and supported in their interior, having adsorption capacity based on the absorbent particles and mechanical filtering capacity based on the polyurethane foam which can be used directly in the manufacture of filtering systems.

13. A filtering base material of polyurethane foam according to claim 12, wherein it has a specific gravity between 15 kg/m³ up to 85 kg/m³, preferentially between 25 and 45 kg/m³, with different cell sizes and with open cell volume fraction higher than 95%.

14. A filtering base material of polyurethane foam according to claim 13 wherein it is additionally impregnated with a solution of auto-adhesive glue or a solution of polymer with, permanent tackiness that improves the retention of solid particles, with corresponding improvement in the filtering capabilities.

15. A process according to claim 12, further comprising use of the filtering base materials in filters, namely in general air condition and ventilation systems, in the cleansing of air, water, ion-exchange, deodorization, drying, prevention of public hazards, or for the separation and purification

16. A process according to claim 1, further comprising a foam forming formulation comprising a mixture of at least one polyisocyanate, at least one polyol, at least one silicone oil, at least one catalyst and water, and solid adsorbents cleaned by heating before its inclusion in the foaming formulation.
